(19) United States
(12) Patent Application Publication
(10) Pub. No.: US 2010/0181458 A1
(43) Pub. Date: Jul. 22, 2010

(54) Suction cup combination

(76) Inventor: Woody Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,604

(22) Filed: Jun. 17, 2009

(30) Foreign Application Priority Data
Jan. 21, 2009 (TW) 098102315

(51) Int. Cl. F16B 47/00

(52) U.S. Cl. 248/363

(57) ABSTRACT

A suction cup combination having a base enveloped by an enveloping member made of elastomer, the enveloping member is shaped to have a peripheral extension and forms a suction cup together with a plate or a plurality of plates; when in use, a vacuum state is formed between the suction cup and a plane being adsorbed, thus the structure and the process of assembling of the suction cup combination can be simplified.

### BACKGROUND OF THE INVENTION

1. Field of the Invention

The present invention is related to a suction cup combination, and especially to use elastomer to envelop a plate of a base to form a suction cup.

2. Description of the Prior Art

A technique of prior art is owned by the applicant and published on Oct. 1, 2006, the technique is a patent titled “SUCTION DISC UNIT” with a publication No. M298,663 granted by R.O.C.; the patent case has a corresponding U.S. patent US 2007 0290105, it comprises: a pressing lid, a suction disc, a link and a pressing rod; wherein the pressing rod has at least a first eccentric protruding port ion, and at least a second eccentric protruding portion, when the pressing rod is pulled up to make the suction disc adequately stick to a smooth surface, this is favorable to removal of air as much as possible; when the pressing rod is pressed down, the pressing lid abuts against the periphery of the suction disc, and the link moves upwards to pull tight the central portion of the suction disc, hence air pressure in a gap between the suction disc and the smooth surface is much smaller than that of the atmosphere to thereby induce a strong suction force, thus bearing strength of the suction disc unit can be increased.

The process of assembling of the conventional technique needs to be simplified, thereby, a novel mode of production and a novel structure shall be provided.

### SUMMARY OF THE INVENTION

The primary object of the present invention is to provide a suction cup combination in which an enveloping member made of elastomer is used to envelop a plate of a base to form a suction cup. The enveloping member is shaped to have a peripheral extension to form a suction cup.

The gain of effect that the present invention is to have resides in simplifying the structure and the process of assembling of the suction cup combination, and lowering its cost of production.

The technical measures of the present invention can be practised in a plurality of kinds of suction cup combinations:

One suction cup combination of the present invention comprises:

a base having a plurality of plates and a neck;

an enveloping member enveloping the plates and the neck in the mode of insert-molding, the enveloping member is shaped to have a peripheral extension; wherein the enveloping member is made of elastomer and forms a suction cup together with the plates.

Another suction cup combination of the present invention comprises:

a base having a plurality of plates and a neck, the tailing ends of the plates are all connected with an annular frame;

an enveloping member enveloping the plates, the annular frame and the neck by insert-molding with a mold, the enveloping member is formed to have an extension; wherein the enveloping member is made of elastomer and forms a suction cup together with the plates.

A third suction cup combination of the present invention comprises:

a base having a plate and a neck;

an enveloping member enveloping the plate and the neck by insert-molding with a mold, the enveloping member is formed to have an extension; wherein the enveloping member is made of elastomer and forms a suction cup together with the plate.

A fourth suction cup combination of the present invention comprises:

a base having a plurality of plates and a neck;

an enveloping member including an upper and a lower enveloping layer, the upper enveloping layer has a flange adapted to fixing on the neck, the upper and the lower enveloping layers envelope the plates by combining in a mode of high frequency melting; wherein the enveloping member is made of elastomer and has an extension, and forms a suction cup together with the plates.

A fifth suction cup combination of the present invention comprises:

a base having a plate and a neck;

an enveloping member including an upper and a lower enveloping layer, the upper enveloping layer has a flange adapted to fixing on the neck, the upper and the lower enveloping layers envelope the plate by combining in a mode of high frequency melting; wherein the enveloping member is made of elastomer and has an extension, and forms a suction cup together with the plate.

A sixth suction cup combination of the present invention comprises:

a base having a plurality of plates and a neck;

an enveloping member including an upper and a lower enveloping layer, the upper enveloping layer has a flange adapted to fixing on the neck, the upper and the lower enveloping layers envelope the plates by combining using an adhesive agent; wherein the enveloping member is made of elastomer and has an extension, and forms a suction cup together with the plates.

A seventh suction cup combination of the present invention comprises:

a base having a plate and a neck;

an enveloping member including an upper and a lower enveloping layer, the upper enveloping layer has a flange adapted to fixing on the neck, the upper and the lower enveloping layers envelope the plate by combining using an adhesive agent; wherein the enveloping member is made of elastomer and has an extension, and forms a suction cup together with the plate.

An eighth suction cup combination of the present invention comprises:

a plastic base having a plate and a neck;

an elastic plastic enveloping member enveloping the plate and the neck and is formed to have an extension; wherein hardness of the plastic base is larger than that of the plastic enveloping member, the enveloping member forms a flange at the neck, and forms a suction cup together with the plate.

The present invention will be apparent in its features, technical measures and the particular functions to be achieved after reading the detailed description of the preferred embodiment thereof in reference to the accompanying drawings.

### BRIEF DESCRIPTION OF THE DRAWINGS

FIG. 1 is a perspective view of a preferred embodiment of the present invention;

FIG. 2 is an anatomic perspective view of the preferred embodiment of the present invention;

FIG. 3 is a sectional view taken from a sectional line A-A of FIG. 1;

FIG. 4 is a sectional view showing use of the preferred embodiment of the present invention;

FIG. 5 is an anatomic perspective view of a second embodiment of the present invention;

FIG. 6 is an anatomic perspective view of a third embodiment of the present invention;

FIG. 7 is a schematic sectional view of a fourth embodiment of the present invention;

FIG. 8 is a schematic sectional view of a fifth embodiment of the present invention;

FIG. 9 is a schematic sectional view of a sixth embodiment of the present invention;

FIG. 10 is a schematic sectional view of a seventh embodiment of the present invention.

### DETAILED DESCRIPTION OF THE PREFERRED EMBODIMENT

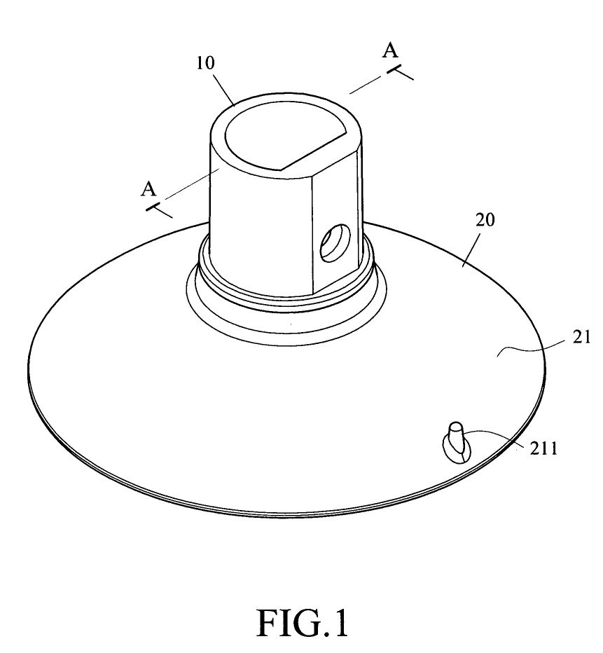

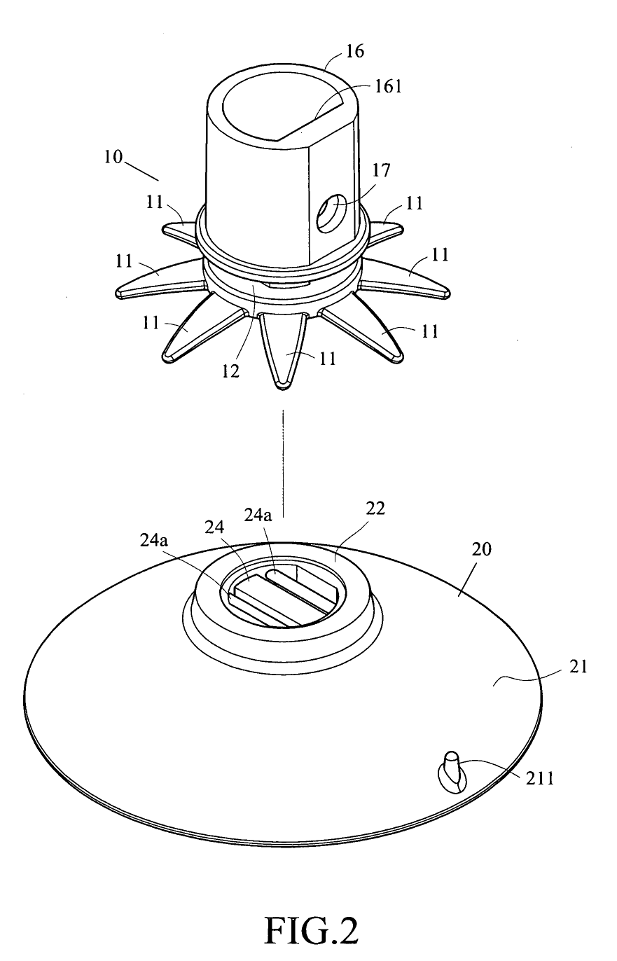

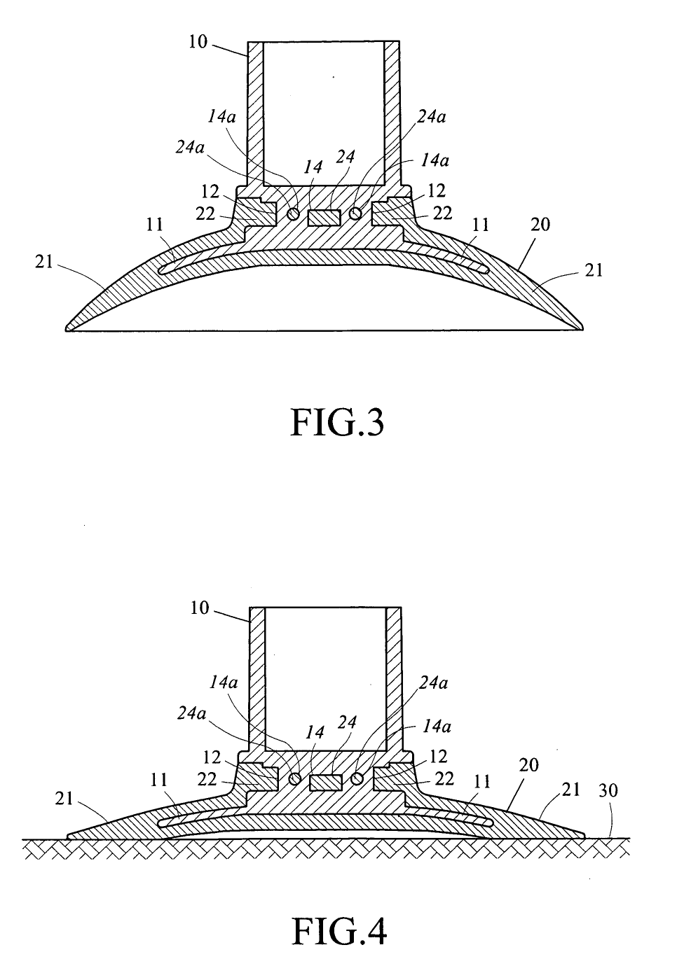

Referring firstly to FIGS. 1 to 3, in this preferred embodiment, a suction cup combination of the present invention comprises: a base 10 and an enveloping member 20, the base 10 has a plurality of plates 11 and a neck 12; the enveloping member 20 envelopes the plates 11 and the neck 12 in the mode of insert-molding to form a suction cup, the enveloping member 20 is shaped to have a peripheral extension 21 and forms a flange 22 at the neck 12; wherein the enveloping member 20 is made of elastomer such as polyethylene chloride (PVC), NBR synthetic rubber, silicone rubber, polyaminoester rubber, fluorine rubber, or electric conductive rubber; the base 10 can be made of poly formaldehyde (POM), polypropylene (PP), ABS, poly carbonate ester or metal; thereby the structure and process of assembling of the suction cup can be simplified, and in turn the cost of production of the suction cup can be reduced.

And more, the thickness of the sectional area of the enveloping member 20 can be uniform; or can be gradually reduced from the center of the enveloping member 20 outwards, thus the thickness of the peripheral extension 21 is smaller and more elastic, the peripheral extension 21 further can be provided with a post 211. The base 10 has a head 12 which can be provided with a fixing hole (such as a rectangular fixing hole 14, a round fixing hole 14a or a fixing hole of some other shape), thereby when the enveloping member 20 is shaped by insert-molding, it can be formed to have a positioning rib (such as a rectangular fixing rib 24, a round fixing rib 24a or a fixing rib of some other shape) in the fixing hole, hence the combining strength of the base 10 with the enveloping member 20 can be increased.

Moreover, the base 10 can further be provided with a fixing sleeve 16 of which an inner side has a plane wall 161, the fixing sleeve 16 can further be provided with a fixing hole 17, so that the fixing sleeve 16 can be connected with a member or article.

Referring simultaneously to FIGS. 1 and 4, when in pressing a plane 30 of the suction cup combination of the present invention, air under the enveloping member 20 can be extruded outwards, and when in releasing the pressing force, the plates 11 of the base 10 can provide an upwardly acting restoring force, thereby a vacuum state is formed between the enveloping member 20 and the plane 30, and the peripheral extension 21 can be tightly clung to the plane 30 to surely keep the vacuum state; when the vacuum state is relieved, one can pull the post 211 of the peripheral extension 21 in order that the suction cup combination can be separated from the plane 30 easily.

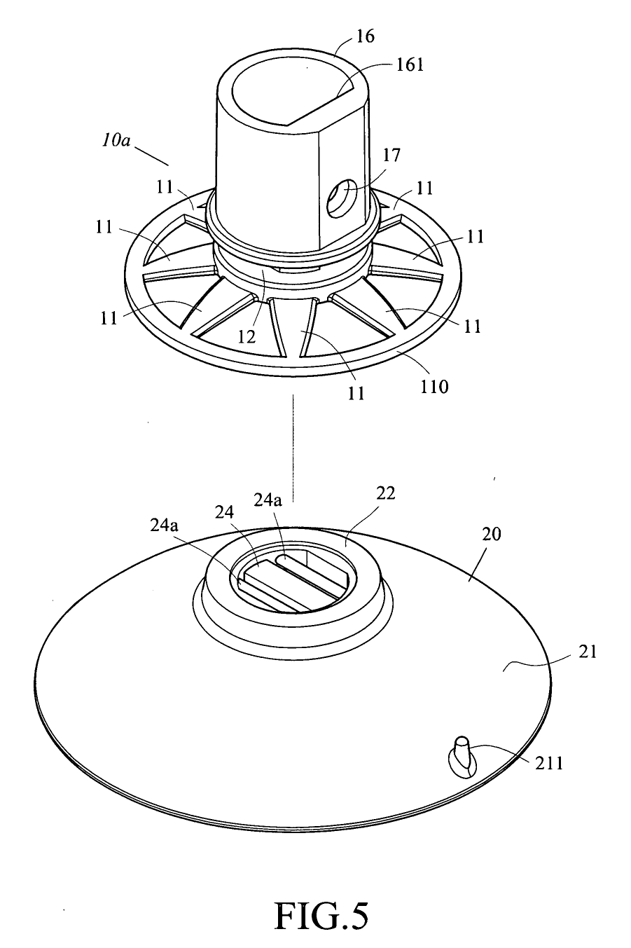

Referring to FIG. 5 showing a second embodiment of the present invention, wherein a base 10a has a plurality of plates 11 and a neck 12; the ends of the plurality of plates 11 are all connected at their tailing ends with an annular frame 110; an enveloping member 20 made of elastomer envelopes the plates 11, the annular frame 110 and the neck 12 in the mode of insert-molding to form a suction cup.

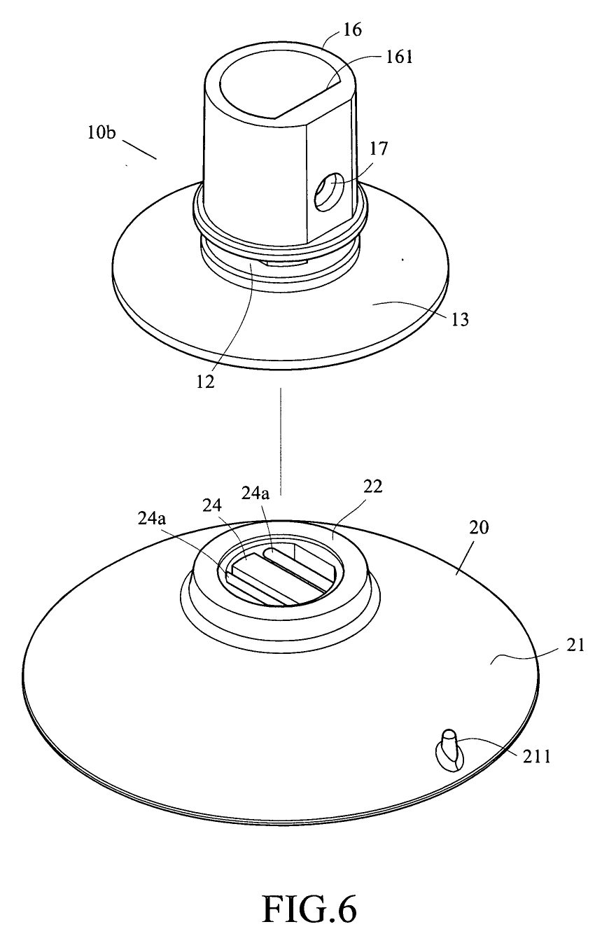

Referring to FIG. 6 showing a third embodiment of the present invention, wherein a base 10b has a plate 13 and a neck 12; an enveloping member 20 made of elastomer envelopes the plate 13 and the neck 12 by insert-molding, the enveloping member 20 is formed to have an extension 21 and to form a suction cup.

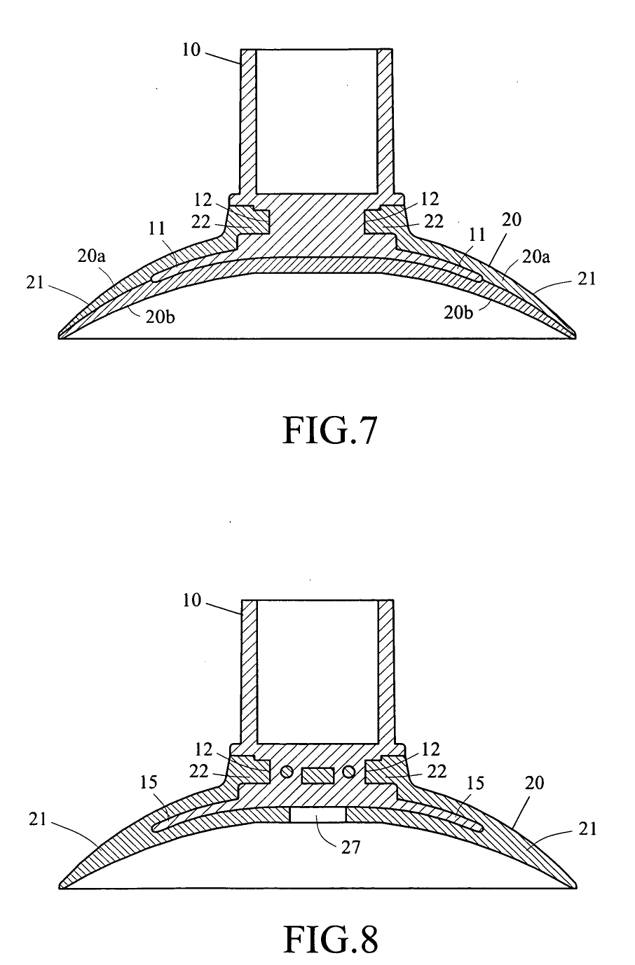

Referring to FIG. 7 showing a fourth embodiment of the present invention, wherein an enveloping member 20 made of elastomer is composed of an upper enveloping layer 20a and a lower enveloping layer 20b, the upper enveloping layer 20a has a flange 22 adapted to fixing on the neck 12, the upper and the lower enveloping layers 20a, 20b can be combined with each other in a mode of high frequency melting or by using adhesive agent to envelope the plates 11 of a base 10. Or as shown in FIG. 5, the enveloping member 20 can envelope the plates 11 of the base 10a and the annular frame 110. Or as shown in FIG. 6, the enveloping member 20 can envelop the cup shaped plates 13 of the base 10b, the enveloping member 20 is formed to have an extension 21.

Referring to FIG. 8 showing a fifth embodiment of the present invention, wherein the suction cup combination of the present invention comprises: a plastic base 10 having an elastic plastic enveloping member 20, the plastic base 10 has a plate 15 and a neck 12, the enveloping member 20 envelops the plate 15 and the neck 12; the enveloping member 20 is formed to have an extension 21, and the thickness of the sectional area of the enveloping member 20 is gradually reduced from the center of the enveloping member 20 outwards, thus the thickness of the peripheral extension 21 is smaller and more elastic; wherein hardness of the plastic base 10 is larger than that of the plastic enveloping member 20, the enveloping member 20 forms a flange 22 at the neck 12, and forms a suction cup together with the plates 15. Moreover, the enveloping member 20 can completely envelops the plates 15 and the neck 12, or can be provided centrally with a hole 27.

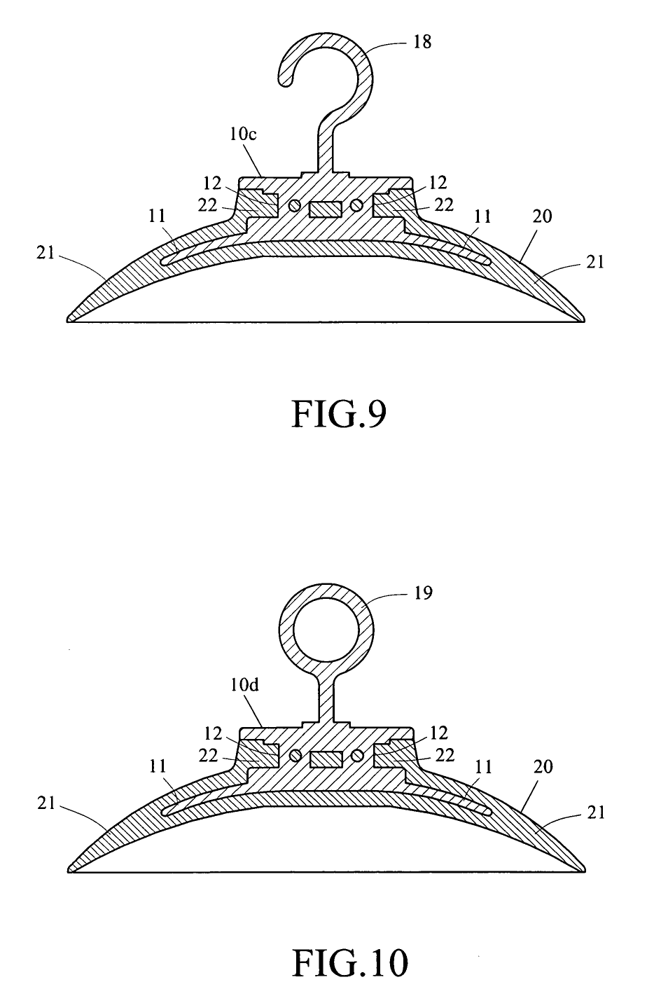

Referring to FIG. 9 showing a sixth embodiment of the present invention, wherein a base 10c is provided with a hook 18 for the purpose to get connected or to be hung on an article.

Referring to FIG. 10 showing a seventh embodiment of the present invention, wherein a base 10d is provided with an circular hanging hook 19 for the purpose to get connected or to be hung on an article.

In conclusion, according to the description disclosed above, the present invention surely can get the expected objects thereof, and there has been no product with the features same as those of the present invention. Having thus described the invention, what I claim as new and desire to be secured by Letters Patent of the United States is:

1. A suction cup combination comprising:
a base having a plurality of plates and a neck;
an enveloping member enveloping said plates and said neck in a mode of insert-molding, said enveloping member is shaped to have a peripheral extension; wherein said enveloping member is made of elastomer and forms a suction cup together with said plates.

2. The suction cup combination as in claim 1, wherein:
said enveloping member is made of polyethylene chloride (PVC), NBR synthetic rubber, silicone rubber, polyaminoester rubber, fluorine rubber, or electric conductive rubber; said base is made of poly formaldehyde (POM), polypropylene (PP), ABS, poly carbonate ester or metal.

3. The suction cup combination as in claim 1, wherein:
thickness of sectional area of said enveloping member is gradually reduced from a center of said enveloping member outwards, and said peripheral extension further is provided with a post; said neck of said base is provided with a fixing hole, thereby when said enveloping member is shaped by insert-molding, said enveloping member is formed to have a positioning rib in said fixing hole and forms a flange at said neck.

4. The suction cup combination as in claim 1, wherein:
said plates are all connected at their tailing ends with an annular frame.

5. The suction cup combination as in claim 4, wherein:
said enveloping member is made of polyethylene chloride (PVC), NBR synthetic rubber, silicone rubber, polyaminoester rubber, fluorine rubber, or electric conductive rubber; said base is made of poly formaldehyde (POM), polypropylene (PP), ABS, poly carbonate ester or metal.

6. The suction cup combination as in claim 4, wherein:
thickness of sectional area of said enveloping member is gradually reduced from a center of said enveloping member outwards, and said peripheral extension further is provided with a post; said neck of said base is provided with a fixing hole, thereby when said enveloping member is shaped by insert-molding, said enveloping member is formed to have a positioning rib in said fixing hole and forms a flange at said neck.

7. A suction cup combination comprising:
a base having a plate and a neck;
an enveloping member enveloping said plate and said neck in a mode of insert-molding, said enveloping member is shaped to have a peripheral extension; wherein said enveloping member is made of elastomer and forms a suction cup together with said plate.

8. The suction cup combination as in claim 7, wherein:
said enveloping member is made of polyethylene chloride (PVC), NBR synthetic rubber, silicone rubber, polyaminoester rubber, fluorine rubber, or electric conductive rubber; said base is made of poly formaldehyde (POM), polypropylene (PP), ABS, poly carbonate ester or metal.

9. The suction cup combination as in claim 7, wherein:
thickness of sectional area of said enveloping member is gradually reduced from a center of said enveloping member outwards, and said peripheral extension further is provided with a post; said neck of said base is provided with a fixing hole, thereby when said enveloping member is shaped by insert-molding, said enveloping member is formed to have a positioning rib in said fixing hole and forms a flange at said neck.

10. A suction cup combination comprising:
a base having at least a plate and a neck;
an enveloping member enveloping including an upper and a lower enveloping layer, the upper enveloping layer has a flange adapted to fixing on said neck, said upper and said lower enveloping layers envelope said at least a plate by combining with each other; wherein said enveloping member is made of elastomer and has an extension, and forms a suction cup together with said at least a plate.

11. The suction cup combination as in claim 10, wherein:
said enveloping member is made of polyethylene chloride (PVC), NBR synthetic rubber, silicone rubber, polyaminoester rubber, fluorine rubber, or electric conductive rubber; said base is made of poly formaldehyde (POM), polypropylene (PP), ABS, poly carbonate ester or metal.

12. The suction cup combination as in claim 10, wherein:
said at least a plate includes a plurality of plates which are all connected at their tailing ends with an annular frame.

13. The suction cup combination as in claim 12, wherein:
said upper and said lower enveloping layers are combined with each other in a mode of high frequency melting or by using adhesive agent.

14. The suction cup combination as in claim 10, wherein:
said at least a plate is one plate and is in shape of a cup.

15. The suction cup combination as in claim 14, wherein:
said upper and said lower enveloping layers are combined with each other in a mode of high frequency melting or by using adhesive agent.

16. A suction cup combination comprising:
a plastic base having a plate and a neck;
a plastic enveloping member enveloping said plate and said neck, said enveloping member is shaped to have a peripheral extension; wherein hardness of said plastic base is larger than that of said plastic enveloping member, said enveloping member forms a flange at said neck, and forms a suction cup together with said plate.

17. The suction cup combination as in claim 16, wherein:
said base is provided with an integrally formed fixing sleeve of which an inner side has a plane wall, said fixing sleeve further is provided with a fixing hole.

18. The suction cup combination as in claim 16, wherein:
said base is provided with a hanging hook or a circular hanging hook.

19. The suction cup combination as in claim 16, wherein:
said enveloping member is provided centrally with a hole, and said peripheral extension of said enveloping member further is provided with a post.

20. The suction cup combination as in claim 16, wherein:
thickness of sectional area of said enveloping member is gradually reduced from a center of said enveloping member outwards.
